(19) United States
(12) Patent Application Publication
(10) Pub. No.: US 2026/0022496 A1
(43) Pub. Date: Jan. 22, 2026

(54) SHEATH-CORE COMPOSITE FIBER AND PREPARATION METHOD THEREFOR AND USE THEREOF

(71) Applicant: FUJIAN INSTITUTE OF RESEARCH ON THE STRUCTURE OF MATTER, CHINESE ACADEMY OF SCIENCES, Fuzhou, Fujian (CN)

(72) Inventors: Longhui ZHENG, Fuzhou, Fujian (CN); Yuanye ZHANG, Fuzhou, Fujian (CN); Haopeng WANG, Fuzhou, Fujian (CN); Jianlei WANG, Fuzhou, Fujian (CN); Lixin WU, Fuzhou, Fujian (CN)

(21) Appl. No.: 18/996,424

(22) PCT Filed: Oct. 20, 2023
(86) PCT No.: PCT/CN2023/125755

§ 371 Date: Jan. 17, 2025

(30) Foreign Application Priority Data
Oct. 28, 2022 (CN) 202211338799.6

(51) Int. Cl. D01D 5/34; C01B 32/19; C01B 32/21; D01D 1/02; D01D 5/08; D01F 1/10; D01F 8/12; D01F 8/14

(52) U.S. Cl. CPC D01D 5/34; C01B 32/19; C01B 32/21; D01D 1/02; D01D 5/08; D01F 1/103; D01F 8/12; D01F 8/14; C01P 2002/72; C01P 2002/82; C01P 2004/03; C01P 2004/04; D10B 2101/12; D10B 2331/02; D10B 2331/04; D10B 2401/063; D10B 2401/13; D10B 2401/16

(57) ABSTRACT

A sheath-core composite fiber and a preparation method therefor and a use thereof are provided. The sheath-core composite fiber is prepared by taking modified graphene master batch as a sheath layer and a high polymer material as a core layer for melt spinning. The sheath-core composite fiber has both antistatic and antibacterial functions and good mechanical strength.

The present application claims priority to the prior application with the patent application No. 202211338799.6 and entitled “SHEATH-CORE COMPOSITE FIBER AND PREPARATION METHOD THEREFOR AND USE THEREOF” filed to the China National Intellectual Property Administration on Oct. 28, 2022, the content of which is incorporated herein by reference in its entirety.

### TECHNICAL FIELD

The present disclosure mainly relates to the technical field of fibers, and particularly to a sheath-core composite fiber and a preparation method therefor and use thereof.

### BACKGROUND

Graphene is a honeycomb-shaped crystal with a single two-dimensional layer of carbon atoms, and is currently known as the thinnest two-dimensional carbon nanomaterial. Due to the unique large x-conjugated system of graphene, graphene has excellent physicochemical characteristics, such as ultrahigh specific surface area, excellent electric and thermal conductivity, special optical properties, and excellent mechanical properties. With the above characteristics, graphene has broad application prospects in the fields of energy, electronics, coating materials, fibers, and the like.

The large-scale preparation of graphene is the key to the application of graphene. Although there are many methods for preparing graphene, including epitaxial growth, mechanical stripping, electrochemical stripping, and chemical vapor deposition, there are various limitations which greatly limits the practical industrial application of graphene. For example, the Hummers method requires a strong oxidant, which is not environmentally friendly, and destroys the structure of graphene; and chemical vapor deposition has severe preparation conditions and high production cost.

In recent years, in the textile field, many research results clearly prove that graphene can significantly improve various properties of a polymer, including mechanical properties, heat and electricity conduction, barrier properties, and the like. The functional graphene fiber is prepared mainly by the following three ways. Firstly, the fiber surface is processed in a physical or chemical method, so that graphene is loaded on the fiber surface, and the functional fiber prepared by this method has obvious defects in the aspect of water washing resistance due to poor interaction force between the graphene and the fiber, and is easy to lose the functionality of the fiber. Secondly, the graphene is added during blending or composite spinning, so that the fiber is modified. However, the graphene itself has a strong agglomeration effect, so that the graphene is difficult to be re-dispersed under the condition of shearing and stirring during blending, defects are easily formed in the fiber, the mechanical strength of the fiber is reduced, and the phenomena of broken filaments and fuzzing occur during spinning. Moreover, the amount of the graphene added is limited, so that the characteristics of the graphene are difficult to fully exert. Thirdly, the modified fiber is prepared by adopting an in-situ polymerization method. However, since special polymerization environments such as low water content, high vacuum, and the like are needed in the fiber polymerization stage, nano-graphene added can easily interfere the polymerization reaction, so that the polymerization degree of the fiber is greatly limited, resulting in reduced product quality. Therefore, the development of a multifunctional graphene composite fiber with good mechanical strength is of great significance.

### SUMMARY

In order to solve the technical problems described above, the technical solutions provided by the present disclosure are as follows.

The present disclosure provides a preparation method for a composite fiber, comprising the following steps:
(1) mixing a carbon nanosphere, graphite, and water to prepare a pretreated carbon nanosphere/graphite dispersion;
(2) subjecting the pretreated carbon nanosphere/graphite dispersion obtained in step (1) to stripping to prepare a graphene dispersion;
(3) adding a metal source to the graphene dispersion obtained in step (2) to obtain a metal-loaded graphene dispersion;
(4) drying the metal-loaded graphene dispersion obtained in step (3) to obtain a graphene-loaded metal complex;
(5) melt blending the graphene-loaded metal complex obtained in step (4) and a polymer material to prepare a modified graphene masterbatch; and
(6) performing a melt spinning with the modified graphene masterbatch obtained in step (5) as a sheath component and a polymer material as a core component to prepare the composite fiber.

According to embodiments of the present disclosure, in step (1), the carbon nanosphere may be prepared by taking a monosaccharide as a starting material and using a hydrothermal method.

According to embodiments of the present disclosure, in step (1), the starting material for preparing the carbon nanosphere is a monosaccharide, wherein the monosaccharide is selected from at least one of glucose, fructose, galactose, and the like.

According to embodiments of the present disclosure, the reaction of the hydrothermal method is performed at a temperature of 100-300° C., such as 160-200° C., illustratively 100° C., 120° C., 130° C., 150° C., 160° C., 180° C., 200° C., 220° C., 240° C., 260° C., 280° C., or 300° C.

According to embodiments of the present disclosure, the monosaccharide in the hydrothermal method is at a concentration of 1-60 mg/mL, such as 10-50 mg/mL, illustratively 1 mg/mL, 5 mg/mL, 10 mg/mL, 20 mg/mL, 30 mg/mL, 40 mg/mL, 50 mg/mL, or 60 mg/mL.

According to embodiments of the present disclosure, the hydrothermal method is performed for a reaction period of 5-10 h, such as 6-8 h, illustratively 5 h, 6 h, 7 h, 8 h, 9 h, or 10 h.

According to embodiments of the present disclosure, in step (1), the graphite is selected from at least one of natural flake graphite, expanded graphite, graphite powder, and the like. Further, the graphite is in the form of powder. For example, the graphite powder has a mesh size of 80-5000 meshes, illustratively 80, 200, 300, 325, 500, 750, 1000, 1200, 1500, 2000, 3000, 4000, or 5000 meshes.

According to embodiments of the present disclosure, in step (1), the graphite in the pretreated carbon nanosphere/graphite dispersion is at a concentration of 1-50 mg/mL, such as 5-25 mg/mL, illustratively 1 mg/mL, 5 mg/mL, 10 mg/mL, 25 mg/mL, 30 mg/mL, 40 mg/mL, or 50 mg/mL.

According to embodiments of the present disclosure, step (1) may specifically be: (1a) preparing a carbon nanosphere using a hydrothermal method, and adding graphite to the carbon nanosphere aqueous solution to obtain a pretreated carbon nanosphere/graphite dispersion.

According to embodiments of the present disclosure, step (1) may also be: (1b) adding graphite and a monosaccharide to water for mixing, and performing a hydrothermal treatment to convert the monosaccharide into a carbon nanosphere to obtain a pretreated carbon nanosphere/graphite dispersion. Preferably, in step (1b), a high-shear dispersing emulsifier may be used for mixing.

According to embodiments of the present disclosure, in step (1b), a treatment time of using the high-shear dispersing emulsifier is 1-100 min, such as 5-50 min, illustratively 5 min, 25 min, 50 min, 75 min, or 100 min.

According to embodiments of the present disclosure, in step (1b), the high-shear dispersing emulsifier is at a rotation speed of 1000-15000 rpm, such as 5000-10000 rpm, illustratively 5000 rpm, 8000 rpm, or 10000 rpm.

According to embodiments of the present disclosure, step (1) may also be: (1c) adding graphite and a monosaccharide to water, performing a hydrothermal treatment to convert the monosaccharide into a carbon nanosphere, and mixing to obtain a pretreated carbon nanosphere/graphite dispersion.

Preferably, in step (1c), mixing may be performed in an ultrasonic mode.

According to embodiments of the present disclosure, in step (2), the pretreated carbon nanosphere/graphite dispersion is added to a shearing device having an ultrahigh shearing rate for stripping to obtain a graphene dispersion.

Preferably, the shearing device having an ultrahigh shearing rate includes, but is not limited to: a microfluidizer, etc.

According to embodiments of the present disclosure, step (2) may specifically be: stripping the pretreated carbon nanosphere/graphite dispersion in a microfluidizer. The specific process of step (2) is: circulating the pretreated carbon nanosphere/graphite dispersion for 1-5 times (illustratively 1, 3, or 5 times) through a 200-400 μm (illustratively 200 μm, 300 μm, or 400 μm) nozzle at a pressure of 3000-5000 psi (illustratively 3000 psi, 4000 psi, or 5000 psi), and then circulating it for 1-50 times (illustratively 3, 5, or 7 times) through a 100-200 μm (illustratively 100 μm, 150 μm, or 200 μm) nozzle at a pressure of 15000-22000 psi (illustratively 15000 psi, 18000 psi, or 22000 psi).

According to embodiments of the present disclosure, in step (2), a stripping time is 10-100 min.

According to embodiments of the present disclosure, in step (3), the metal source is selected from at least one of the following substances or a solution containing the substance: silver nitrate, copper nitrate, and zinc nitrate.

Illustratively, the metal source is a silver nitrate solution having a concentration of 0.1-1 mol/L, such as 0.1-0.5 mol/L, illustratively 0.1 mol/L, 0.3 mol/L, or 0.5 mol/L.

According to embodiments of the present disclosure, in step (4), the drying is for example a freeze-drying. Preferably, a time of the freeze-drying is 1-96 h, such as 24 h, 48 h, or 72 h. A temperature of the freeze-drying is −50° C. to −10° C., illustratively −30° C.

According to embodiments of the present disclosure, in step (5), the graphene in the modified graphene masterbatch has a mass fraction of 0.005-0.8%, such as 0.1-0.5%, illustratively 0.1%, 0.2%, 0.3%, 0.4%, or 0.5%.

According to embodiments of the present disclosure, in step (5), the polymer material is a polymer commonly used in the art for preparing fiber. For example, it is selected from at least one of nylon, dacron, and spandex, illustratively polyester or nylon 6.

According to embodiments of the present disclosure, in step (6), in the composite fiber, the mass fraction of the sheath component in a total mass of the composite fiber is 10-30%, such as 10-20%, illustratively 10%, 15%, or 20%.

The present disclosure further provides a composite fiber comprising a sheath layer and a core layer.

According to embodiments of the present disclosure, a mass fraction of the sheath layer in the composite fiber is 10-30%, such as 10%, 20%, or 30%.

According to embodiments of the present disclosure, the core layer comprises a polymer material, and the polymer material is defined as above.

According to embodiments of the present disclosure, the sheath layer is a modified graphene masterbatch. Preferably, the modified graphene masterbatch comprises a graphene-loaded metal complex and the polymer material. Preferably, a mass fraction of the graphene-loaded metal complex in the modified graphene masterbatch is 0.005-0.8%, such as 0.1-0.5%, illustratively 0.1%, 0.2%, 0.3%, 0.4%, or 0.5%.

According to embodiments of the present disclosure, in order to make the sheath layer and the core layer of the composite fiber have a relatively good interfacial compatibility, the polymer materials in the core layer and the sheath layer are preferably the same polymer material. Illustratively, the polymer materials in the sheath layer and the core layer are both selected from at least one of nylon, dacron, and spandex, illustratively polyester or nylon 6.

According to embodiments of the present disclosure, the graphene-loaded metal complex comprises a nanometal or a metal ion, and a modified graphene. Preferably, the nanometal or the metal ion is selected from at least one of Ag, Cu, and Zn.

According to embodiments of the present disclosure, the modified graphene is prepared by the following method: mixing a carbon nanosphere and graphite to obtain the modified graphene, wherein the carbon nanosphere is loaded on the surface of the graphene.

According to embodiments of the present disclosure, the nanometal or the metal ion is deposited in situ on the modified graphene, preferably on the carbon nanosphere. Loading amount of the nanometal or the metal ion is not particularly limited in the present disclosure, and may be selected from those known in the art.

According to embodiments of the present disclosure, the modified graphene has 1-10 layer(s), and has a lateral dimension of 0.5-10 μm.

According to embodiments of the present disclosure, the carbon nanosphere is prepared by taking a monosaccharide as a starting material through a hydrothermal method.

According to embodiments of the present disclosure, the monosaccharide is selected from at least one of glucose, fructose, galactose, and the like.

According to embodiments of the present disclosure, the graphite is selected from at least one of natural flake graphite, expanded graphite, graphite powder, and the like. Further, the graphite is in the form of powder. For example, the graphite powder has a mesh size of 80-5000 meshes.

According to embodiments of the present disclosure, the composite fiber has a breaking strength of more than 3 cN/dtex, such as 3.1-6 cN/dtex, and further such as 3.5 cN/dtex, 4 cN/dtex, 5 cN/dtex, or 6 cN/dtex.

According to embodiments of the present disclosure, the composite fiber has a specific resistance of less than 1×10⁷ Ω·cm, such as 1×10⁶ to 9.5×10⁶ Ω·cm.

According to embodiments of the present disclosure, the composite fiber has excellent antistatic and/or antibacterial functions, and the like.

According to embodiments of the present disclosure, the composite fiber is prepared by the preparation method described above.

The present disclosure further provides use of the composite fiber described above, such as in the field of functional textiles.

### Beneficial Effects of the Present Disclosure

(1) According to the present disclosure, using graphite as a starting material, a carbon nanosphere prepared with a monosaccharide by a hydrothermal method as a stripping auxiliary, and water as a dispersion medium, a carbon nanosphere-modified graphene is prepared in one step through a microfluidizer. This method does not require a pre-treatment with strong acids or strong oxidants, which is a green, environmentally friendly, and simple route.
(2) By utilizing the x-x conjugation between the carbon nanosphere and graphene, a carbon nanosphere-modified graphene is directly prepared during the stripping process. This not only preserves the intact structure of graphene but also endows graphene with excellent dispersibility due to the abundant functional groups on the surface of the carbon nanosphere.
(3) The surface structural characteristics of the carbon nanosphere are fully utilized to prepare a graphene-loaded metal complex by in-situ deposition of nanometals or metal ions. This further prevents graphene from stacking and ensures the uniform dispersion of nanometals or metal ions on the surface of graphene.
(4) In the present disclosure, the graphene-loaded metal complex is combined with a polymer material to form a modified graphene masterbatch. Using the modified graphene masterbatch as the sheath layer, and a polymer material as the core layer, a composite fiber is prepared via a melt spinning, retaining the inherent mechanical strength of the fibers while reducing the amount of functional components added.
(5) The composite fibers prepared by the present disclosure exhibit excellently antistatic and antibacterial properties, offering promising application prospects.

### BRIEF DESCRIPTION OF THE DRAWINGS

FIG. 1 shows infrared spectrums of the carbon sphere modified graphene and the graphene-loaded nanosilver complex in Example 1.

FIG. 2 shows an EDX spectrum of the graphene-loaded nanosilver complex in Example 1.

FIG. 3 shows an XRD spectrum of the graphene-loaded nanosilver complex in Example 1.

FIG. 4 shows digital photographs of the graphene dispersions prepared in Example 1 and Comparative Example 1 after being placed for one week.

FIG. 5 shows a TEM image of the carbon nanosphere modified graphene prepared in Example 1.

FIG. 6 shows a microphotograph of the sheath-core composite fiber prepared in Example 1.

FIG. 7 shows SEM images of the fibers prepared in Example 1 and Comparative Example 3.

FIG. 8 shows an SEM image of a cross-section of the sheath-core composite fiber in Example 1.

### DETAILED DESCRIPTION

The technical solutions of the present disclosure will be further described in detail with reference to the following specific examples. It will be appreciated that the following examples are merely exemplary illustrations and explanations of the present disclosure and should not be construed as limiting the claimed scope of the present disclosure. All techniques implemented on the basis of the content described above of the present disclosure are encompassed within the claimed scope of the present disclosure.

Unless otherwise stated, the starting materials and reagents used in the following examples are all commercially available products or can be prepared by using known methods.

### Example 1

A sheath-core composite fiber is prepared by the following steps:
(1) 325-mesh graphite powder and glucose were first added to water to prepare a graphite powder/glucose dispersion. The graphite powder had a concentration of 25 mg/mL and glucose had a concentration of 10 mg/mL. The dispersion described above was sheared and mixed for 5 min using a high-shear dispersing emulsifier at a rotation speed of 8000 rpm, and held at 180° C. for 7 h to convert glucose into a carbon nanosphere, thereby obtaining a pretreated carbon nanosphere/graphite dispersion.
(2) The pretreated carbon nanosphere/graphite dispersion was added to a microfluidizer, circulated for 1 time through a 300 μm nozzle at the pressure of 5000 psi, and circulated for 3 times through a 100 μm nozzle at the pressure of 18000 psi to obtain a graphene dispersion, in which the graphene was a graphene modified by a carbon nanosphere.
(3) 10 mL of a 0.5 mol/L silver nitrate solution was added to 100 mL of the graphene dispersion to obtain a nanosilver-loaded graphene dispersion.
(4) The nanosilver-loaded graphene dispersion was freeze-dried at −30° C. for 72 h to obtain a graphene-loaded nanosilver complex.
(5) The graphene-loaded nanosilver complex and a polyester chip (DuPont, U.S.A., FC02 BK507, the same below) were melt blended to prepare a modified graphene polyester masterbatch having a graphene content of 0.1%.
(6) Using the modified graphene polyester masterbatch having the graphene content of 0.1% as a sheath component and the polyester chip as a core component, a sheath-core composite fiber was prepared through a melt spinning machine, wherein a sheath layer had a mass fraction of 30%.

### Example 2

A sheath-core composite fiber is prepared by the following steps:
(1) Fructose and water were mixed to prepare a fructose/water solution at the concentration of 30 mg/mL. 750-mesh graphite powder was added to the fructose/water solution described above to prepare a fructose/graphite dispersion at the concentration of 10 mg/mL. The fructose/graphite dispersion was sheared and mixed for 25 min using a high-shear dispersing emulsifier at a rotation speed of 8000 rpm, and subjected to a hydrothermal treatment at 200° C. for 7 h to convert fructose into a carbon nanosphere, thereby obtaining a pretreated carbon nanosphere/graphite dispersion.
(2) The pretreated carbon nanosphere/graphite dispersion was added to a microfluidizer, circulated for 3 times through a 300 μm nozzle at the pressure of 4000 psi, and circulated for 3 times through a 150 μm nozzle at the pressure of 18000 psi to obtain a graphene dispersion, in which the graphene was a graphene modified by a carbon nanosphere.
(3) 10 mL of a 0.1 mol/L silver nitrate solution was added to 100 mL of the graphene dispersion to obtain a nanosilver-loaded graphene dispersion.
(4) The nanosilver-loaded graphene dispersion was freeze-dried at −30° C. for 72 h to obtain a graphene-loaded nanosilver complex.
(5) The graphene-loaded nanosilver complex and a nylon 6 chip (Baling Petrochemical, BL3240H, the same below) were melt blended to prepare a modified graphene nylon 6 masterbatch having a graphene content of 0.5%.
(6) Using the modified graphene nylon 6 masterbatch having the graphene content of 0.5% as a sheath component and the nylon 6 chip as a core component, a sheath-core composite fiber was prepared through a melt spinning machine, wherein a sheath layer had a mass fraction of 30%.

### Example 3

A sheath-core composite fiber is prepared by the following steps:
(1) Glucose and water were mixed to prepare a glucose/water solution at the concentration of 50 mg/mL. The solution was held at 160° C. for 6 h to prepare a carbon nanosphere/water solution at the concentration of 50 mg/mL. 1200-mesh graphite powder was added to the carbon nanosphere/water solution described above to prepare a carbon nanosphere/graphite dispersion at the concentration of 5 mg/mL. The dispersion was stirred until the system was uniform to obtain a pretreated carbon nanosphere/graphite dispersion.
(2) The pretreated carbon nanosphere/graphite dispersion was added to a microfluidizer, circulated for 3 times through a 250 μm nozzle at the pressure of 5000 psi, and circulated for 5 times through a 100 μm nozzle at the pressure of 18000 psi to obtain a graphene dispersion, in which the graphene was a graphene modified by a carbon nanosphere.
(3) 10 mL of a 0.3 mol/L silver nitrate solution was added to 100 mL of the graphene dispersion to obtain a nanosilver-loaded graphene dispersion.
(4) The nanosilver-loaded graphene dispersion was freeze-dried at −30° C. for 24 h to obtain a graphene-loaded nanosilver complex.
(5) The graphene-loaded nanosilver complex and a polyester chip were melt blended to prepare a modified graphene polyester masterbatch having a graphene content of 0.3%.
(6) Using the modified graphene polyester masterbatch having the graphene content of 0.3% as a sheath component and the polyester chip as a core component, a sheath-core composite fiber was prepared through a melt spinning machine, wherein a sheath layer had a mass fraction of 10%.

### Example 4

A sheath-core composite fiber is prepared by the following steps:
(1) 2000-mesh graphite powder and galactose were added to water with a concentration of 10 mg/mL for the galactose and a concentration of 25 mg/mL for the graphite powder, held at 180° C. for 7 h to convert galactose into a carbon nanosphere, and subjected to an ultrasonic treatment for 5 min for mixing to obtain a pretreated carbon nanosphere/graphite dispersion.
(2) The pretreated carbon nanosphere/graphite dispersion was added to a microfluidizer, circulated for 5 times through a 200 μm nozzle at the pressure of 5000 psi, and circulated for 7 times through a 100 μm nozzle at the pressure of 22000 psi to obtain a graphene dispersion, in which the graphene was a graphene modified by a carbon nanosphere.
(3) 10 mL of a 0.5 mol/L silver nitrate solution was added to 100 mL of the graphene dispersion to obtain a nanosilver-loaded graphene dispersion.
(4) The nanosilver-loaded graphene dispersion was freeze-dried at −30° C. for 48 h to obtain a graphene-loaded nanosilver complex.
(5) The graphene-loaded nanosilver complex and a nylon 6 chip were melt blended to prepare a modified graphene nylon 6 masterbatch having a graphene content of 0.1%.
(6) Using the modified graphene nylon 6 masterbatch having the graphene content of 0.1% as a sheath component and the nylon 6 chip as a core component, a sheath-core composite fiber was prepared through a melt spinning machine, wherein a sheath layer had a mass fraction of 20%.

### Example 5

A sheath-core composite fiber is prepared by the following steps:
(1) A natural flake graphite and fructose were added to water to prepare a natural flake graphite/fructose dispersion. The natural flake graphite has a concentration of 5 mg/mL and fructose had a concentration of 30 mg/mL. The dispersion described above was sheared and mixed for 50 min using a high-shear dispersing emulsifier at a rotation speed of 5000 rpm, and held at 160° C. for 8 h to convert fructose into a carbon nanosphere, thereby obtaining a pretreated carbon nanosphere/graphite dispersion.
(2) The pretreated carbon nanosphere/graphite dispersion was added to a microfluidizer, circulated for 5 times through a 250 μm nozzle at the pressure of 3000 psi, and circulated for 3 times through a 150 μm nozzle at the pressure of 15000 psi to obtain a graphene dispersion, in which the graphene was a graphene modified by a carbon nanosphere.
(3) 10 mL of a 0.1 mol/L silver nitrate solution was added to 100 mL of the graphene dispersion to obtain a nanosilver-loaded graphene dispersion.
(4) The nanosilver-loaded graphene dispersion was freeze-dried at −30° C. for 48 h to obtain a graphene-loaded nanosilver complex.
(5) The graphene-loaded nanosilver complex and a polyester chip were melt blended to prepare a modified graphene polyester masterbatch having a graphene content of 0.1%.
(6) Using the modified graphene polyester masterbatch having the graphene content of 0.1% as a sheath component and the polyester chip as a core component, a sheath-core composite fiber was prepared through a melt spinning machine, wherein a sheath layer had a mass fraction of 30%.

### Example 6

A sheath-core composite fiber is prepared by the following steps:
(1) An expanded graphite and glucose were added to water to prepare an expanded graphite/glucose dispersion. The expanded graphite had a concentration of 5 mg/mL and glucose had a concentration of 50 mg/mL. The dispersion described above was sheared and mixed for 50 min using a high-shear dispersing emulsifier at a rotation speed of 5000 rpm, and held at 170° C. for 6 h to convert glucose into a carbon nanosphere, thereby obtaining a pretreated carbon nanosphere/graphite dispersion.
(2) The pretreated carbon nanosphere/graphite dispersion was added to a microfluidizer, circulated for 3 times through a 250 μm nozzle at the pressure of 5000 psi, and circulated for 5 times through a 150 μm nozzle at the pressure of 18000 psi to obtain a graphene dispersion, in which the graphene was a graphene modified by a carbon nanosphere.
(3) 10 mL of a 0.1 mol/L silver nitrate solution was added to 100 mL of the graphene dispersion to obtain a nanosilver-loaded graphene dispersion.
(4) The nanosilver-loaded graphene dispersion was freeze-dried at −30° C. for 72 h to obtain a graphene-loaded nanosilver complex.
(5) The graphene-loaded nanosilver complex and a polyester chip were melt blended to prepare a modified graphene polyester masterbatch having a graphene content of 0.2%.
(6) Using the modified graphene polyester masterbatch having the graphene content of 0.2% as a sheath component and the polyester chip as a core component, a sheath-core composite fiber was prepared through a melt spinning machine, wherein a sheath layer had a mass fraction of 20%.

### Comparative Example 1

A sheath-core composite fiber is prepared by the following steps:
The preparation method of Comparative Example 1 is essentially the same as that of Example 1 except that: when preparing graphene, the carbon nanosphere is not added, namely, glucose is not added in step (1), and only water is used as a medium to obtain a pretreated graphite dispersion; in step (2), the pretreated graphite dispersion is prepared into a graphene dispersion using the same process as that of Example 1, wherein the graphene is not modified by a carbon nanosphere. The other steps are the same as those of Example 1, and a sheath-core composite fiber is prepared.

### Comparative Example 2

A composite fiber is prepared by the following steps:
The preparation method of Comparative Example 2 is essentially the same as that of Example 1 except that: in step (6), the sheath component and the core component are both the modified graphene polyester masterbatch, namely, the modified graphene polyester masterbatch having a graphene content of 0.1% in step (5) is directly subjected to spinning to obtain the composite fiber.

### Comparative Example 3

A polyester fiber is prepared by the following steps:
The preparation method of Comparative Example 3 is essentially the same as that of Example 1 except that: in step (6), the modified graphene masterbatch is not added, namely, the polyester chip is used as both the sheath component and the core component to prepare the polyester fiber.

### Test Example

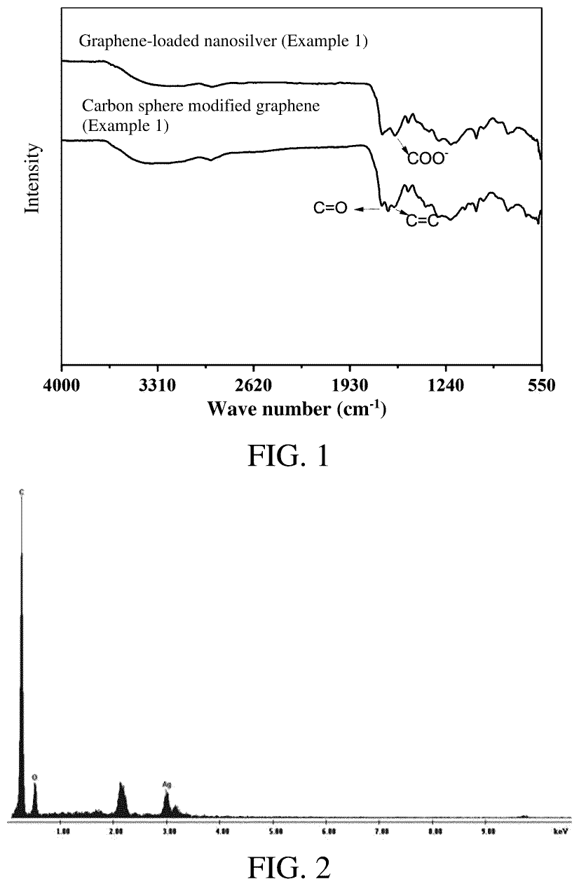

The graphene sample modified by the carbon nanosphere in step (2) of Example 1 (named as carbon sphere modified graphene) and the graphene-loaded nanosilver complex sample in step (4) (named as graphene-loaded nanosilver) were taken for infrared spectrum tests. FIG. 1 shows infrared spectrums of a carbon sphere modified graphene sample and a graphene-loaded nanosilver complex sample in Example 1 of the present disclosure. It can be seen that the graphene modified by a carbon nanosphere exhibited an absorption peak around 3400 cm⁻¹ corresponding to-OH, a small peak near 2925 cm⁻¹ caused by C—H stretching vibration, a peak at 1697 cm⁻¹ corresponding to C═O stretching vibration, a peak at 1651 cm⁻¹ attributed to the conjugated alkene skeleton vibration, and a peak at 1508 cm⁻¹ likely due to phenyl ring skeleton vibration. These functional groups indicate that the primary functional groups on the carbon nanosphere are —OH and C═O, and dehydration condensation and aromatization are occurred during the process of hydrothermal treatment. After reacting with silver nitrate, an absorption peak at 1604 cm⁻¹ corresponding to COO⁻ stretching vibration is appeared, suggesting that an oxidation-reduction reaction took place on the surface of the carbon nanosphere.

FIG. 2 shows an EDX spectrum of a graphene-loaded nanosilver complex in Example 1 of the present disclosure. According to the EDX spectrum, C, O, and Ag elements are present on the surface of the graphene-loaded nanosilver complex sample.

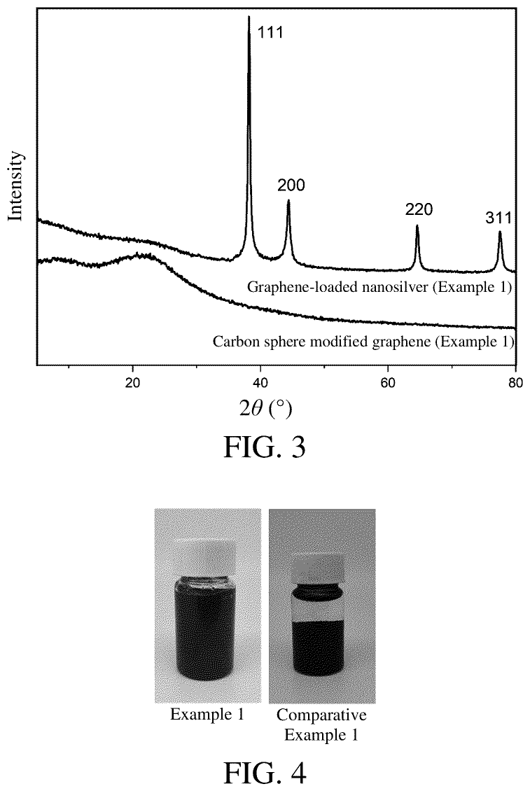

FIG. 3 shows an XRD spectrum of graphene-loaded nanosilver in Example 1 of the present disclosure. As can be seen from the XRD spectrum, after reacting with silver nitrate, four distinct diffraction peaks appeared at 38.1°, 44.4°, 64.6°, and 77.5°, which correspond to (111), (200), (220), and (311) crystal planes of the silver fcc structure (JCPDS No. 04-0783), respectively.

Further, it can be determined that silver was loaded on the surface of the carbon nanosphere. FIG. 4 shows digital photographs of the graphene dispersions prepared in step (2) of Example 1 and Comparative Example 1 of the present disclosure after being placed for 1 week. It can be seen that after being placed for one week, the graphene dispersion prepared in Example 1 showed no obvious sedimentation, and still had excellent dispersibility, while the graphene dispersion prepared in Comparative Example 1 showed an obvious layering phenomenon. This is mainly due to the fact that in Example 1, carbon nanospheres are used as a stripping auxiliary to act together with graphene to obtain the graphene modified by carbon sphere, so that graphene has excellent dispersibility, which is benefited from abundant functional groups on the surfaces of the carbon nanospheres.

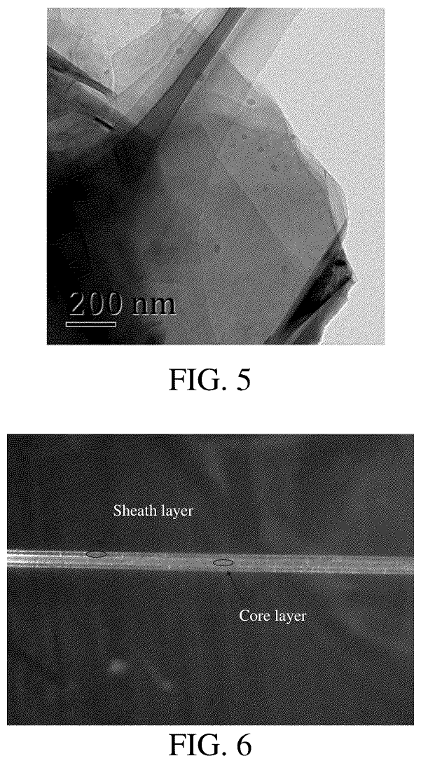

FIG. 5 shows a TEM image of the carbon sphere modified graphene prepared in Example 1 of the present disclosure. It can be seen that the carbon nanospheres were uniformly adsorbed on the surface of graphene.

FIG. 6 shows a microphotograph of the sheath-core composite fiber prepared in Example 1. It can be seen that the sheath layer and the core layer exhibited distinct sheath and core structures under light because of the different compositions.

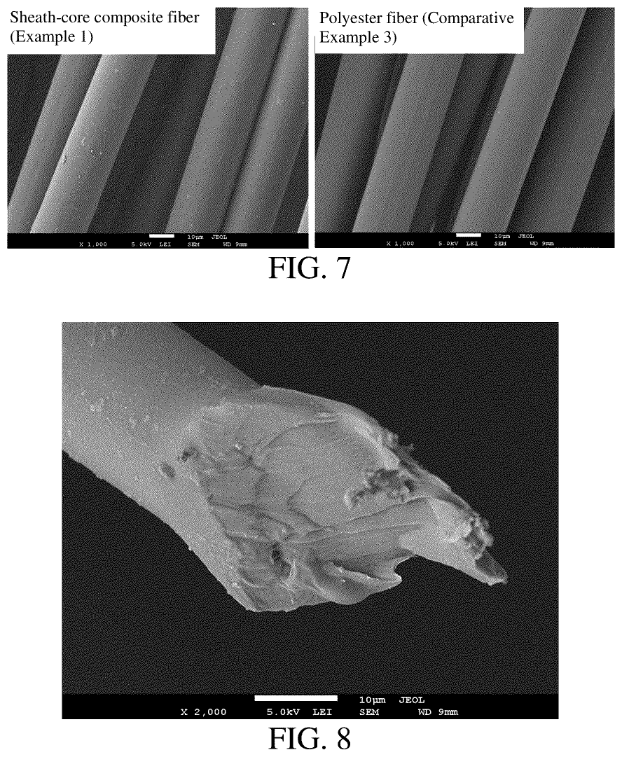

FIG. 7 shows SEM images of the fibers prepared in Example 1 and Comparative Example 3. By comparison, it can be seen that, the composite fiber in which the polyester masterbatch was used as the sheath layer had a rough surface, wherein the polyester masterbatch was prepared from the graphene-loaded nanosilver complex; while the polyester fiber prepared from the polyester chip as the sheath layer had a relatively smooth surface.

FIG. 8 shows an SEM image of a cross-section of the sheath-core composite fiber prepared in Example 1. It can be seen that the interface bonding between the sheath layer and the core layer was excellent, and no defects occurred therebetween.

As can be seen from Table 1, compared with Example 1, the composite fiber prepared in Comparative Example 1 has a relatively poor performance because the sheath layer in Comparative Example 1 is prepared from graphene not modified by carbon nanosphere which is easily stacked and agglomerated. Comparing Example 1 with Comparative Example 2, it can be seen that in the sheath-core structure according to the present disclosure, the breaking strength of the polyester fiber is greatly maintained, while the polyester fiber obtained by directly spinning the modified graphene masterbatch has a very low breaking strength. Comparing Examples 1-6 with Comparative Example 3, it can be seen that by introducing the graphene-loaded nanosilver complex into the fiber as the functional component, the fiber has a reduced specific resistance so that the composite fiber has excellent antistatic performance and antibacterial effect, wherein the antibacterial rates were not less than 92%.

TABLE 1
Properties of fibers

| | | | Antibacterial | Antibacterial |
|---|---|---|---|---|
| | Breaking | Specific | rate of | rate of |
| | strength^{A} | resistance^{B} | Staphylococcus | Escherichia |
| Sample | (cN/dtex) | (Ω · cm) | aureus^{C} (%) | coli^{C} (%) |
| Example 1 | 3.55 | 6.2 × 10⁶ | 93 | 94 |
| Example 2 | 5.52 | 1.6 × 10⁶ | 97 | 96 |
| Example 3 | 3.65 | 8.9 × 10⁶ | 95 | 95 |
| Example 4 | 5.80 | 8.0 × 10⁶ | 92 | 93 |
| Example 5 | 3.50 | 7.5 × 10⁶ | 94 | 93 |
| Example 6 | 3.58 | 7.8 × 10⁶ | 94 | 95 |
| Comparative | 2.92 | 1.4 × 10⁹ | 76 | 68 |
| Example 1 | | | | |
| Comparative | 1.18 | 8.2 × 10⁷ | 96 | 95 |
| Example 2 | | | | |
| Comparative | 3.62 | 9.0 × 10¹¹ | 42 | 48 |
| Example 3 | | | | |

^{A}was tested according to GB/T 3916-2013;
^{B}was tested according to GB/T 14342-2015; and
^{C}was tested according to GB/T 20944.3-2008.

The exemplary embodiments of the present disclosure have been described above. However, the protection scope of the present application is not limited to the above embodiments. Any modification, equivalent, improvement, and the like made by those skilled in the art without departing from the spirit and principle of the present disclosure shall fall within the protection scope of the present disclosure.

1. A preparation method for a composite fiber, comprising the following steps:
(1) mixing a carbon nanosphere, graphite, and water to prepare a pretreated carbon nanosphere/graphite dispersion;
(2) subjecting the pretreated carbon nanosphere/graphite dispersion obtained in step (1) to stripping to prepare a graphene dispersion;
(3) adding a metal source to the graphene dispersion obtained in step (2) to obtain a metal-loaded graphene dispersion;
(4) drying the metal-loaded graphene dispersion obtained in step (3) to obtain a graphene-loaded metal complex;
(5) melt blending the graphene-loaded metal complex obtained in step (4) and a polymer material to prepare a modified graphene masterbatch; and
(6) performing a melt spinning with the modified graphene masterbatch obtained in step (5) as a sheath component and a polymer material as a core component to prepare the composite fiber.

2. The preparation method according to claim 1, wherein in step (1), the carbon nanosphere is prepared by taking a monosaccharide as a starting material and using a hydrothermal method;
preferably, in step (1), a monosaccharide is used as the starting material for preparing the carbon nanosphere, wherein the monosaccharide is selected from at least one of glucose, fructose, and galactose;
preferably, the hydrothermal method is performed at a reaction temperature of 100-300° C.;
preferably, the monosaccharide in the hydrothermal method is at a concentration of 1-60 mg/mL;
preferably, the hydrothermal method is performed for a reaction period of 5-10 h;
preferably, in step (1), the graphite is selected from at least one of natural flake graphite, expanded graphite, and graphite powder;
preferably, in step (1), the graphite in the pretreated carbon nanosphere/graphite dispersion is at a concentration of 1-50 mg/mL.

3. The preparation method according to claim 1, wherein step (1) is: (1a) preparing a carbon nanosphere using a hydrothermal method, and adding graphite to a carbon nanosphere aqueous solution to obtain a pretreated carbon nanosphere/graphite dispersion;
preferably, step (1) is: (1b) adding graphite and a monosaccharide to water for mixing, and performing a hydrothermal treatment to convert the monosaccharide into a carbon nanosphere, thereby obtaining a pretreated carbon nanosphere/graphite dispersion;
preferably, in step (1b), a high-shear dispersing emulsifier may be used for mixing;
preferably, in step (1b), the high-shear dispersing emulsifier is used for a treatment time of 1-100 min;
preferably, in step (1b), the high-shear dispersing emulsifier is at a rotation speed of 1000-15000 rpm;
preferably, step (1) is: (1c) adding graphite and a monosaccharide to water, performing a hydrothermal treatment to convert the monosaccharide into a carbon nanosphere, and mixing to obtain a pretreated carbon nanosphere/graphite dispersion;
preferably, in step (1c), the mixing may be performed in an ultrasonic mode.

4. The preparation method according to claim 1, wherein in step (2), the pretreated carbon nanosphere/graphite dispersion is added to a shearing device having an ultrahigh shearing rate for stripping to obtain a graphene dispersion;
preferably, step (2) is: stripping the pretreated carbon nanosphere/graphite dispersion in a microfluidizer, preferably the specific process is: circulating the pretreated carbon nanosphere/graphite dispersion for 1-5 times through a 200-400 μm nozzle at a pressure of 3000-5000 psi, and then circulating it for 1-50 times through a 100-200 μm nozzle at a pressure of 15000-22000 psi;
preferably, in step (2), a stripping time is 10-100 min.

5. The preparation method according to claim 1, wherein in step (3), the metal source is selected from at least one of the following substances or a solution containing the substance: silver nitrate, copper nitrate, and zinc nitrate;
preferably, in step (4), the drying is a freeze-drying; preferably, the freeze-drying is performed for a period of 1-96 h; preferably, the freeze-drying is performed at a temperature of −50° C. to −10° C.;
preferably, in step (5), the graphene in the modified graphene masterbatch has a mass fraction of 0.005-0.8%;
preferably, in step (6), in the composite fiber, the sheath component has a mass fraction of 10-30% in the total mass of the composite fiber.

6. A composite fiber, comprising a sheath layer and a core layer.

7. The composite fiber according to claim 6, wherein the sheath layer in the composite fiber has a mass fraction of 1-30%;
preferably, the core layer comprises a polymer material.

8. The composite fiber according to claim 6, wherein the sheath layer is prepared from a modified graphene masterbatch; preferably, the modified graphene masterbatch comprises a graphene-loaded metal complex and a polymer material; preferably, the graphene-loaded metal complex in the modified graphene masterbatch has a mass fraction of 0.005-0.8%;
preferably, the graphene-loaded metal complex comprises a nanometal or a metal ion, and a modified graphene; preferably, the nanometal or the metal ion is selected from at least one of Ag, Cu, and Zn;
preferably, the nanometal or the metal ion is deposited in situ on the modified graphene, preferably on the carbon nanosphere;
preferably, the modified graphene has 1-10 layer(s), and has a lateral dimension of 0.5-10 μm;
preferably, the carbon nanosphere is prepared by taking a monosaccharide as a starting material through a hydrothermal method.

9. The composite fiber according to claim 6,
wherein the composite fiber has a breaking strength of more than 3 cN/dtex;
preferably, the composite fiber has a specific resistance of less than 1×10⁷ Ω·cm;
preferably, the composite fiber has excellent antistatic and/or antibacterial functions.

10. Use of the composite fiber according to claim 6.
